(19) United States
(12) Patent Application Publication
(10) Pub. No.: US 2007/0137996 A1
(43) Pub. Date: Jun. 21, 2007

(54) Method and apparatus for simultaneous heat and mass transfer utilizing a carrier-gas

(76) Inventor: James R Beckman, Tempe, AZ (US)

Correspondence Address: DAVID S. HARPER;McDONNELL BOEHNEN HULBERT & BERGHOFF LLP, 300 SOUTH WACKER DRIVE, SUITE 3100, CHICAGO, IL, 60606, US

(21) Appl. No.: 10/527,374

(22) PCT Filed: Sep. 10, 2003
(86) PCT No.: PCT/US03/28432

§ 371 Date: Mar. 10, 2005

Related U.S. Application Data
(60) Provisional application No. 60/409,687, filed on Sep. 10, 2002.
(60) Provisional application No. 60/419,867, filed on Oct. 21, 2002.

(51) Int. Cl. B01D 3/34; B01D 3/14

(52) U.S. Cl. 202/158; 203/49

(57) ABSTRACT

The invention disclosed herein relates to a continuous contacting apparatus for separating a liquid component from a liquid mixture. In one embodiment, the apparatus includes a first chamber having first and second ends, a second chamber having first and second ends, and a common heat transfer wall capable of providing thermal communication between the first chamber and the second chamber. Two condensors/heat exchangers can also be connected to the two chambers. In an another embodiment, the invention relates to a continuous contacting apparatus for exchanging heat released by a desiccant. The apparatus includes a heat-releasing chamber, a heat-absorbing chamber, a common heat transfer wall capable of providing thermal communication between the heat-releasing chamber and the heat producing chamber, and a desiccant regenerator.

### CROSS REFERENCE TO RELATED APPLICATION

This application claims priority to U.S. provisional application Ser. No. 60/419,867 filed on Oct. 21, 2002 and U.S. provisional application Ser. No. 60/409,687 filed on Sep. 10, 2002, both of which are incorporated by reference herein in their entirety.

### FEDERALLY SPONSORED RESEARCH

This project was partially funded by financial assistance provided by the United States Government through the Bureau of Reclamation, Financial Agreement Nos. 98-FC-81-0049 and 99-FC-81-0186; and the United States Government may own certain rights to this invention.

### FIELD OF THE INVENTION

This invention relates to a method and apparatus for the efficient separation of liquid mixtures, which may contain dissolved solids, wherein one or more liquid components have differing vapor pressures from the remaining components. In particular, the present invention relates to a method and apparatus for utilizing a carrier gas to separate a liquid component from a liquid mixture, which may include dissolved salts.

### BACKGROUND OF THE INVENTION

International Patent Application No. PCT/US00/20336 (WO 01/07134), which is incorporated herein in its entirety, disclosed a novel technology called “Dewvaporation.” This technology can be used to efficiently separate (e.g., concentrate, purify, fractionate, or strip) a liquid component from a liquid mixture using a carrier gas. Several advantages of Dewvaporation over conventional separation techniques (e.g., reverse osmosis, mechanical vapor compression, multi-stage flash distillation, and multi-effect distillation with and without thermal vapor compression) were also described.

The continuous contacting Dewvaporation apparatuses described in International Patent Application No. PCT/US00/20336 generally included an evaporation chamber and a dew-formation chamber, which were separated by a common heat transfer wall. Once the liquid mixture is fed onto the evaporation side of the heat transfer wall, the separable liquid component is evaporated into a carrier gas. The heat needed for evaporation is supplied by the heat released from the dew fall condensation, i.e., formation of dew from the vapor, of the separable component from the carrier gas onto the opposite side of a heat transfer wall in the dew-formation chamber.

An embodiment disclosed in International Patent Application No. PCT/US00/20336 is illustrated by FIG. 1. A continuous contacting column 5 includes a heat transfer wall 10, which separates the following two vertically extending portions of the column: (i) an evaporation portion of column 15 (evaporation chamber), i.e., the portion of the column where the separable component is evaporated from the liquid mixture into a carrier gas, and (ii) a dew-formation portion of the column 20 (dew-formation chamber), i.e., the portion of the column where the separable component in the carrier gas is condensed. Liquid mixture feed 30 is introduced into the top of the evaporation portion so that the liquid mixture is in physical contact with evaporation side 14 of heat transfer wall 10, and brine 40, i.e., the remaining concentrated liquid mixture, exits at the bottom of the evaporation portion of the column. Carrier gas 50 is introduced at the bottom of the evaporation portion of column 15, and saturated carrier gas 55, i.e., containing the separable liquid component, exits the top of evaporation portion of the column 15. A minor portion 57 (e.g., less than about 15% by volume) of the saturated carrier gas can be used to pre-heat the liquid mixture feed by heat exchange or direct contact. Alternatively, heat (indicated as Q_{Feed} stream 35) can be added to feed liquid mixture 30.

After adding heat (Q) 70, heated saturated carrier gas 60 is introduced into the top of dew-formation portion of the column 20. Any additional amount of heat is sufficient, e.g., even to increase the temperature of the saturated carrier gas less than 1° C., as long as the saturated carrier gas is hotter at the inlet to the dew-formation side than the outlet from the evaporation side. Virtually any external heat source can be used to provide the necessary additional heat because: (1) only a small amount of external heat is needed to establish temperature differences across the wall at any given height of the column; and (2) the temperature of the external heat is versatile. The additional heat can be obtained from virtually any source, e.g., low temperature solar heat, waste heat, or heat from combustible fuels. In one embodiment, the additional heat is provided by the addition of steam.

The additional heat provides a temperature gradient on the dew-formation side of the heat exchange wall 12 that is higher (e.g. starting at a higher temperature) than the temperature gradient on the evaporation side of heat exchange wall 14. Thus, at any given height or length of the column, the average temperature on the dew-formation portion 20 of the column is greater than the average temperature on the evaporation portion 15 of the column. The additional amount of heat 70 and the flow rate of the carrier gas is chosen to optimize (i) evaporation of the separable liquid component in the evaporation portion of the column, and (ii) condensation of the separable liquid component in the dew-formation portion of the column. Thus, it is preferable to have the dew point temperature within the temperature gradient of the dew-formation portion 20 of the column, and the temperature at a desired vapor pressure of the separable component within the temperature gradient of the evaporation portion 15 of the column. Further heat and mass transfer principles, variables, and equations are described in Bird et al., Transport Phenomena, (John Wiley and Sons 1960) and are well understood by those skilled in the mass/heat transfer arts.

Heated, saturated carrier gas 60 is forced down dew-formation portion 20 of the column by a carrier gas mover (not shown). The carrier gas mover can be any apparatus known in the art that creates positive pressure to move the carrier gas in a particular direction. Nonlimiting examples of useful carrier gas movers include fans, turbines, pumps, and vacuums. The carrier gas mover can be placed at one or more of the inlets and outlets of the dew-formation and evaporation portions of the column. As heated, saturated carrier gas 60 moves down dew-formation portion 20 of the column, heat is transferred across heat transfer wall 10 to the evaporation portion 15 of the column. As a result, the separable liquid component naturally condenses on the dew-formation side of heat transfer wall 12. The condensate containing the separable liquid component is then collected at the bottom or outlet of the heat transfer wall of the dew-formation portion 20 of the column and pumped out as distillate 80. The remaining saturated carrier gas 65 also exits at the bottom of the dew-formation portion of the column. Preferably, the saturated gas exits away from the separated liquid component, i.e., is not bubbled through the distillate. Carrier gas 65 may be discarded or recycled in part or in whole to feed carrier gas stream 50.

The description above from International Patent Application No. PCT/US00/20336 showed application of the basic principles of Dewvaporation technology. The inventor has discovered improvements, which are described herein.

### SUMMARY OF THE INVENTION

One embodiment of the invention disclosed herein relates to a continuous contacting apparatus for separating a liquid component from a liquid mixture. The apparatus includes a first chamber having first and second ends, a second chamber having first and second ends, and a common heat transfer wall capable of providing thermal communication between the first chamber and the second chamber. The first chamber has an inlet and an outlet for a carrier gas, and an inlet and an outlet for a liquid mixture. The inlet for the liquid mixture is located between the first and second ends, the outlet for the liquid mixture and the inlet for the carrier gas are located at the second end of the first chamber, and the outlet for the carrier gas is located at the first end. The second chamber has an inlet and an outlet for a carrier gas, and an inlet and outlet for the separable liquid component. The inlet for the carrier gas and the inlet for the liquid component are located at the first end of the second chamber, and the outlet for the carrier gas and the outlet for the separable liquid component is located at the second end of the second chamber. The inlet for the carrier gas and the inlet for the liquid component at the first end of the second chamber can be a single common inlet, one outlet located at the second end of the second chamber can be used as the outlet for the carrier gas and the outlet for the separable liquid component.

This apparatus can further include two condensors/heat exchangers connected to the two chambers. A first condensor/heat exchanger has an inlet of the cooling chamber connected to the outlet for the carrier gas of the first chamber and an outlet of the cooling chamber connected to the inlet for the carrier gas of the second chamber. A second heat exchanger has an inlet of the cooling chamber connected to the outlet for the carrier gas of the second chamber and an outlet of the cooling chamber connected to the inlet for the carrier gas of the first chamber. The apparatus can also include a feeding device for providing the liquid mixture onto the first chamber side of the heat transfer wall, and a mover for providing a flow of a carrier gas and/or liquid through the chambers.

Another embodiment of the invention relates to a continuous contacting apparatus for exchanging heat released by a desiccant. The apparatus includes a heat-releasing chamber, a heat-absorbing chamber, a common heat transfer wall capable of providing thermal communication between the heat-releasing chamber and the heat producing chamber, and a desiccant regenerator. The heat-releasing chamber has an inlet and an outlet for a gas at least partially saturated with a component absorbable by a desiccant, and an inlet and an outlet for a desiccant. The heat-absorbing chamber has an inlet and an outlet for a gas to be heated. The desiccant regenerator has an inlet and an outlet, wherein the outlet provides a regenerated desiccant stream to the desiccant inlet of the heat-releasing chamber, and wherein the inlet receives spent desiccant stream from the desiccant outlet of the heat-releasing chamber. It is preferred to situate the desiccant inlet of the heat-releasing chamber to place the desiccant onto the heat-releasing side of the heat transfer wall. The desiccant regenerator can regenerate the desiccant by contacting it with heat, heated air, or ambient air.

This apparatus can further include an inlet and an outlet in the heat-absorbing chamber for a liquid having a component evaporable into the gas, and/or a heat exchanger situated between the heat releasing chamber and the desiccant regenerated, the heat exchanger transferring heat from the spent desiccant stream to the regenerated desiccant stream.

### BRIEF DESCRIPTION OF THE DRAWINGS

Further objects and advantages of the present invention will be more fully appreciated from a reading of the detailed description when considered with the accompanying drawings, wherein:

FIG. 1 is a schematic of a prior art apparatus;

FIG. 2 is a schematic of one embodiment of the present invention;

FIG. 3 is a schematic of another embodiment of the present invention;

FIG. 4 is a schematic of another embodiment of the present invention;

FIG. 5 is a graph of water evaporation versus ambient air relative humidity;

FIG. 6 is a graph of condensate/evaporate versus ambient air relative humidity;

FIG. 7 is a schematic of another embodiment of the present invention;

FIG. 8 is a side view schematic of another embodiment of the present invention; and

FIG. 9 is a top view schematic of the embodiment illustrated in FIG. 8.

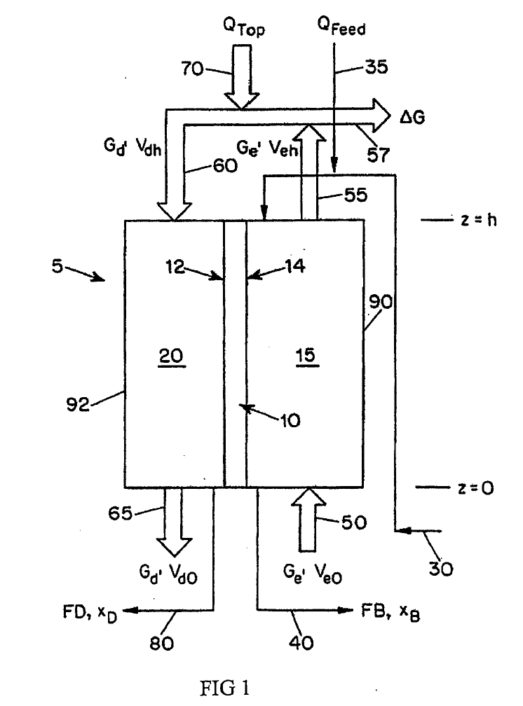

### DETAILED DESCRIPTION OF THE INVENTION

Improvements for Dewvaporation are disclosed herein that can be used to more efficiently separate a liquid component from a liquid mixture using a carrier gas. The term “Dewvaporation,” as used herein, means that a liquid component is separated by first causing it to form a vapor (vaporization) and then causing it to condense (dew formation). The term “liquid mixture,” as used herein, means (i) liquids containing dissolved solids, (ii) liquids having one or more liquid components with differing vapor pressures from the remaining components in the liquid mixture, or (iii) both. The separable component is the part of the liquid mixture that can be separated by evaporation.

The apparatuses of the present invention are continuous contacting, which, as used herein, means that the liquid mixture is maintained in continuous contact with the heat transfer wall and a carrier gas, e.g., without the need for re-applying the liquid mixture onto a portion or sector of the heat transfer wall after the liquid mixture is initially placed onto the heat transfer wall, such as in a multi-stage configuration. Furthermore, the movement of the liquid and the gas is not interrupted by mixing of the liquids ahead or behind a particular length of the apparatus, e.g., mixing within a particular stage. The continuous contacting apparatuses of the present invention, therefore, requires a minimal number of pumps (e.g., it is feasible to use only one pump) to feed the liquid mixture, and does not require a plurality of pumps and nozzles for a plurality of stages. The instant apparatus utilizes slot flow to generate smaller gas film heat transfer coefficients of less than about 50 W/m²° C., preferably about 5 W/m²° C., which result in condensate production fluxes from about 0.045 to about 2.27 kg of condensate per hour/m² of heat transfer wall, preferably from about 0.23 to about 0.91 kg of condensate per hour/m² of heat transfer wall. The term “about,” as used herein, means ±10% of the stated value.

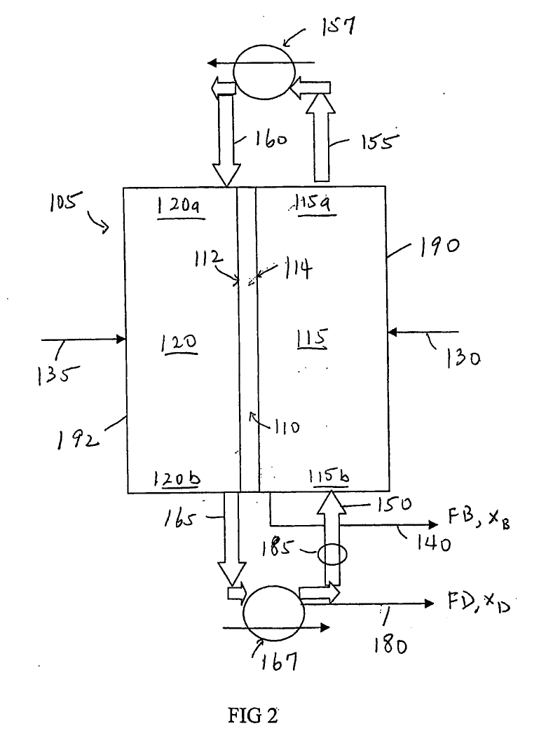

One embodiment of the present invention is illustrated by FIG. 2. This embodiment generally includes a continuous contacting fractionator column 105 that can have a rectifying section 115a and 120a above the feed point and a stripping section 115b and 120b below the feed point. The rectifying section concentrates the most volatile components present in the feed, while the stripping section removes the most volatile components in the feed. The heat transfer wall 110, along with the low temperature condensers/heat exchangers 157 and 167, minimize the energy needs to an amount required for evaporating the distillate product 180 only once. While conventional fractionation requires heat that boils the distillate and heat that boils the reflux, no heat is needed in this embodiment for refluxing the liquid, because energy is recycled by the heat transfer walls.

Continuous contacting fractionator column 105 includes a heat transfer wall 110, which separates two vertically extending portions of the column, a first chamber 115 and a second chamber 120. Liquid mixture feed 130 is introduced into first chamber 115 at any point between the top and the bottom of the chamber, and the brine 140, i.e., the remaining concentrated liquid mixture, exits at the bottom of the first chamber. It is preferred to introduce liquid mixture feed 130 so that it is in physical contact with the first chamber side 114 of the heat transfer wall 110. Preferably, the liquid mixture feed is also introduced at a rate so that the liquid mixture flows down the heat transfer wall in a thin layer, thereby enhancing vaporization and/or condensation of the separable component into the carrier gas as heat is exchanged between first chamber 115 and second chamber 120 across heat transfer wall 110. As is well known in the art, a heat source, such as partially boiled liquid feed or steam, can also be added to the feed.

The inlet for liquid mixture feed 130 can be placed at any location between the top and the bottom of the first chamber. It is preferable to place the inlet at a location that is about the middle (i.e., between the top and bottom) of the first chamber. The placement of the feed determines the rectifying and stripping sections of fractionator column 105, as further described in greater detail below. For example, as illustrated in FIG. 2, the rectifying section becomes the top portions of the first chamber 115a and second chamber 120a, which are located above the feed point, and the stripping section becomes the bottom portions of the first chamber 115b and the second chamber 120b, which is located below the feed point. In the rectifying section of the column, dew-formation of the separable component occurs in the top portion of the first chamber 115a, and evaporation of the separable component occurs in the top portion of the second chamber 120a. In the stripping section, dew-formation of the separable component occurs in the bottom portion of the second chamber 120b, and evaporation of the separable component occurs in bottom portion of the first chamber 115b.

The liquid portion of the feed joins liquid refluxed from the rectifying section (“reflux liquid”) of the first chamber 115a and flows down into the evaporation portion (i.e., the lower stripping section) of the first chamber 115b. Volatile components of this downward flowing liquid is evaporated by convection into an upward flowing carrier gas 150 introduced at the bottom of first chamber 115 and heat received from the dew-formation portion (lower stripping section) of the second chamber 120b. In other words, the volatile components are stripped from the downward flowing liquid in stripping section 115b. The stripped liquid leaves stripping section 115b (bottom portion of the first chamber) as bottoms product 140 with a low concentration of the volatile separable component, which is represented by X_{B}.

The carrier gas may be any gas. Typically, air is chosen due to its abundance and low price. Use of an inert gas may also be desirable to reduce or eliminate corrosion of metallic walls. An example of an excellent low cost inert gas is flue gas (e.g., from a flame after being scrubbed to remove carbon dioxide).

The hot vapor in feed 130 joins the rising hot carrier gas 150, which contains the volatile separable component from stripper section 115b, and enters the bottom of rectifying section 115a (the top portion of the first chamber 115). In rectifying section 115a, energy is removed from the cooling carrier gas/vapor mixture causing dew-formation of the less volatile components in the mixture. The liquid formed from the less volatile components is internal reflux liquid that continuously flows downward into stripping section 115b of the first chamber to be re-evaporated.

The rising carrier-gas in rectifying section 115a continues to cool and deposit liquid reflux until it exits the top of the rectifying section as saturated carrier gas 155. This saturated carrier gas can then be passed through a condenser/heat exchanger 157, where about half of the distillate in the saturated carrier gas forms as liquid distillate by cooling. Any amount of cooling is sufficient. The liquid distillate/carrier gas/vapor mixture 160 is forced down into the top of rectifying section 120a (top portion of the second chamber 120), by a mover (not shown), with the mixture 160 cooler than when the carrier gas/vapor mixture 155, which left rectifying section 115a. The mover can be any apparatus known in the art that creates positive pressure to move the liquid distillate/carrier gas/vapor mixture 160 in a particular direction. Nonlimiting examples of useful carrier gas movers include fans, turbines, pumps, and vacuums. The mover can be placed at one or more of the inlets and outlets of the first and second chambers of the column. It is preferred to direct the liquid distillate onto the second chamber side 112 of the heat transfer wall. The carrier gas/vapor mixture is now in co-current flow with the liquid distillate. The amount of liquid distillate placed onto the second chamber side 112 of the heat transfer wall can be increased as need by returning some of distillate 180. This insures that sufficient heat is withdrawn from rectifying section 115a. Since rectifying section 120a is now cooler than rectifying section 115a, separable components from the liquid distillate formed in the condensor/heat exchanger continue to evaporate into the carrier gas. As the carrier gas/vapor mixture travels down rectifying section 120a, it becomes hotter by receiving heat through heat transfer wall 110 from rectifying section 115a. In this manner, downward flowing carrier gas in rectifying section 120a acts as a heat sink for the rectifying section of the fractionator column 105.

The downward flowing hot carrier gas exits the bottom of rectifying section 120a and enters the top of stripping section 120b (the bottom portion of second chamber 120). At this point, heat 135 can optionally be added to increase the temperature of the carrier gas mixture. Any additional amount of heat is sufficient, e.g., even to increase the temperature of the saturated carrier gas less than 1° C., as long as the saturated carrier gas is hotter before entering stripper section 120b. The additional heat can be obtained from virtually any source, e.g., low temperature solar heat, waste heat, heat from combustible fuels, or heat from desiccant heat pumping applications. In one embodiment, the additional heat can be provided by the addition of steam. In another embodiment, the additional heat can be provided from a desiccant heat exchanger.

The additional amount of heat and the flow rate of the carrier gas is chosen to optimize: (i) evaporation of the separable liquid component in the evaporation portions (i.e., rectifying section 120a and stripper section 115b); and (ii) condensation of the separable liquid component in the dew-formation portions (i.e., rectifying section 115a and stripper section 120b). Preferably, the gas phase and the liquid phase are close to equilibrium conditions. Thus, it is preferable to have the dew point temperature within the temperature gradient of the dew-formation portions, and the evaporation temperature at an applicable vapor pressure of the separable component within the temperature gradient of the evaporation portions. Further heat and mass transfer principles, variables, and equations are described in Bird et al., Transport Phenomena, (John Wiley and Sons 1960) and are well understood by those skilled in the mass/heat transfer arts.

Since the downward flowing carrier gas is now hotter than the evaporation portion of stripping section 115b (lower portion of first chamber 115), the carrier gas in stripping section 120b cools and forms liquid distillate (dew-formation) by providing heat across heat transfer wall 110 to stripping section 115b. Accordingly, the heat energy is recycled from the rectifying section of the column (i.e., from rectifying section 115a to rectifying section 120a ) to the stripping section of the column (i.e., from stripping section 120b to stripping section 115b) for liquid reflux formation.

The cool carrier gas/liquid distillate 165 exits stripping section 120b (and fractionator column 105) and enters second condenser/heat exchanger 167, which removes any remaining heat to form a distillate of the separable component with further cooling. Liquid distillate 180 is removed from the system, and the cool carrier gas 150 is returned to the bottom of stripping section 115b. Alternatively, the distillate 180 can be removed separately from the bottom of stripping section 120b, thereby having only the saturated carrier gas condensed by second condenser/heat exchanger 167. In this alternative, additional distillate can be obtained from second condenser/heat exchanger 167. It is preferred to remove as much volatiles from the carrier gas as possible before it is returned to the bottom of stripping section 115b so that non-separable volatiles are not reintroduced into the fractionator column. One method is to use an absorber 185 with an absorption liquid to dissolve the volatiles in the gas. Liquid feed can be used as the liquid for dissolving the volatiles.

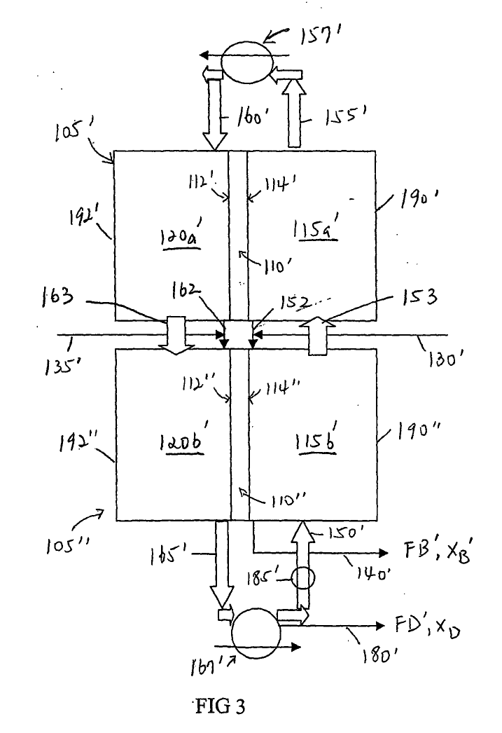

Another embodiment of the present invention is illustrated by FIG. 3, which provides an alternative design for the embodiment of FIG. 2. This embodiment generally includes two continuous contacting fractionator columns 105′ and 105″, which replace the single column of FIG. 2. Accordingly, similar aspects have been assigned the same number as in FIG. 2 but with a prime or double prime next to the number. In this embodiment, column 105′ is a rectifying column, where evaporation occurs in chamber 120a′ and dew-formation occurs in chamber 115a′, and column 105″ is a stripping column, where evaporation occurs in chamber 115b′ and dew-formation occurs in chamber 120b′. All other aspects are virtually the same as the embodiment of FIG. 2, except the two columns are fluidly connected by liquid streams 152 and 162 and carrier gas/vapor streams 153 and 163. Feed 130′ is fluidly connected to liquid stream 152 and/or carrier gas/vapor stream 153 between rectifying section 115a′ and stripping section 115b′. Similarly, optional heat stream 135′ is connected to liquid stream 162 and/or carrier gas/vapor stream 163 between rectifying section 120a′ and stripping section 120b′.

The apparent percentage energy savings of the Dewvaporation technique over that of conventional technique is 100*{1−Dist/(Dist+Reflux)} where “Dist” is the distillate flow rate and “Reflux” is the reflux flow rate that is returned to the top of a conventional fractionator. As an example, the separation of ethanol/water beer mixture requires a reflux flow rate that is about 2.9 times the distillate flow rate, so energy savings of the Dewvaporation technique is about 100*(1−1/(2.9+1))=74%. Also the emission of carbon dioxide, which contribute to global warming, is reduced by the same amount of about 74% due to lower consumption of fuel sources.

By use of the configurations of the present invention the net energy savings becomes a function of a relative volatility, alpha. If a binary feed solution is of 50%/50% composition and the distillate is essentially pure, then the minimum reflux, Rₘ, can be represented as:

$${R}_{m} = \frac{2}{α - 1} \qquad ( 24 )$$

And the energy savings can be expressed as:

$$Savings = \frac{2}{α + 1} \qquad ( 24 )$$

Therefore the potential energy savings for binaries such as ethylbenzene/styrene (α=1.4) is 83%, for benzene/toluene(α=3.1) is 49% and for ethylene glycol/water (α=50) is 4%. For this Dewvaporation design the smaller relative volatility systems show large energy savings when compared to conventional towers. As stated previously, energy savings for Dewvaporation can be larger (e.g., 80%) regardless of the relative volatility by using a design where the zero liquid point is allowed to move into the rectifier from the condenser. The zero point movement can be achieved by the inclusion of another tower that thermally connects to the bottom of the stripper with the distillate (pre condenser).

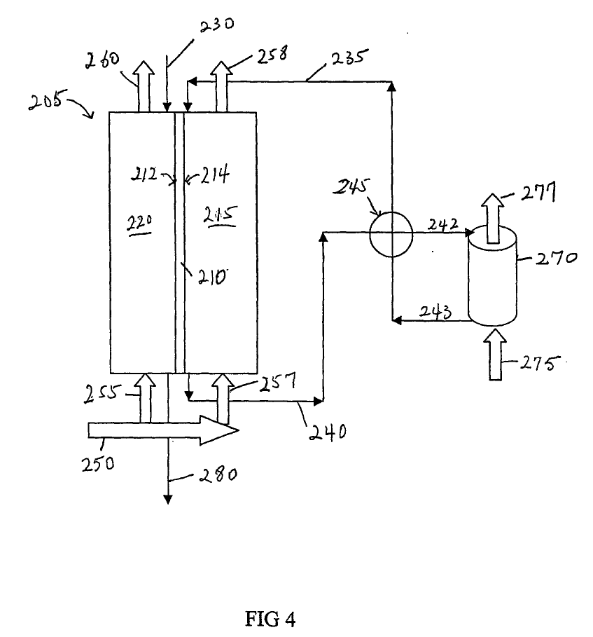

In another embodiment, as illustrated by FIG. 4, the heat and mass transfer principles discussed above are applied to provide a continuous contacting heat exchanger 205. In this embodiment a liquid desiccant can be used to enhance the energy reuse factor, because strong salt solutions have the ability to absorb moisture from air, thereby drying the air and releasing the heat of vaporization. This heat, or any portion thereof can be utilized to do an equal amount of water evaporation into another air stream. Although this embodiment describes application of the heat and mass transfer principles discussed above with desiccants, any other heat generating reaction can be utilized in a similar way.

Continuous contacting heat exchanger 205 includes heat-releasing chamber 215, heat-absorbing chamber 220, and heat transfer wall 210. Heat-releasing chamber 215 has an inlet and an outlet for a gas that is at least partially saturated with a component absorbable by a desiccant, and an inlet and an outlet for a desiccant. Heat-absorbing chamber 220 has an inlet and an outlet for a gas to be heated, and can further include an inlet and an outlet for a liquid 230 having a component evaporable into the gas. As illustrated in FIG. 4, the gas for heat-releasing chamber 215 and heat-absorbing chamber 220 can be the same gas. For example, a slip stream of hot humid air 250 from a Dewvaporation column can be split into gas 255 for heat-releasing chamber 215 and gas 257 for heat-absorbing chamber 220.

Hot humid air 257 is contacted by strong liquid desiccant stream 235 in heat-releasing chamber 215, and heat is provided from the heat-releasing chamber side 214 of heat transfer wall 210 to heat-absorbing chamber side 212 of heat transfer wall 210. It is preferred to introduce the desiccant onto the heat-releasing chamber side 214 of the heat transfer wall at a rate that allows the desiccant to flow down the heat transfer wall in a thin layer, thereby enhancing absorbtion of water by the desiccant from the humid air.

The remaining hot humid air 255 is, thereby, heated as air 255 passes through heat-absorbing chamber 220 and receives heat from heat-releasing chamber 215. The remaining hot humid air 255 can also be further humidified by the evaporation of liquid source 230 having a liquid component evaporable into the air 255, such as feed water, from the energy furnished by heat-releasing chamber 215. Exiting liquid source 280 would, therefore, have less of the evaporable liquid component. The now hotter (or hotter and humid) air stream 260 can be returned to the Dewvaporation column, e.g., into a dew-formation chamber, and dried air 258 can be discarded or returned to the Dewvaporation column, e.g., into the bottom of an evaporation chamber.

Diluted desiccant stream 240 (e.g., diluted by the water vapor absorbed in heat-releasing chamber 215) can be regenerated in regenerator 270. In one embodiment, regenerator 270 is a boiler, which utilizes heated air 275 (or heat alone) to remove the absorbed water to provide regenerated desiccant stream 243. The resulting steam 277 can be reused as a heat source, e.g., in a dew-formation chamber to further increase the temperature and humidity of the returning hot humid air. In an alternative embodiment, regenerator 270 can utilize dry ambient air 275 to remove the absorbed water and produce regenerated desiccant stream 243 and humidified air 277. The amount of energy used in regenerator 270 can be decreased by heat exchanging regenerated desiccant stream 243 with diluted desiccant stream 240. Accordingly, diluted desiccant stream 242 would be at a higher temperature than diluted desiccant stream 240 exiting heat-releasing chamber 215.

The embodiment utilizing ambient air requires virtually no energy for regeneration of the desiccant other than a fan motor and wind. For example, this embodiment would be especially useful in areas of the world where sea water coexists with nearby arid conditions, such as the cities in Table 1 below.

| | |
|---|---|
| CITY | Relative Humidity |

| | | |
|---|---|---|
| | Jan | June |
| USA Yuma, AZ | 26 | 15 |
| USA Phoenix, AZ | 34 | 12 |
| USA Tucson, AZ | 31 | 13 |
| USA Las Vegas, NV | 32 | 10 |
| USA Barstow, CA | 34 | 14 |
| USA Palm Springs, CA | 20 | 15 |
| USA Ridgecrest, CA | 34 | 14 |
| USA San Bernardino, CA | 36 | 15 |
| EGYPT Aswan | 29 | 11 |
| EGYPT Dakhla | 36 | 18 |
| EGYPT Kharga | 39 | 18 |
| EGYPT Luxor | 45 | 17 |
| ISRAEL Odva | 43 | 19 |
| ISRAEL Elat | 36 | 15 |
| SAUDI ARABIA Bishah | 29 | 9 |
| SAUDI ARABIA Medina | 28 | 7 |
| SAUDI ARABIA Riyadh | 32 | 8 |
| SAUDI ARABIA Tabuk | 32 | 12 |
| | Mar | Sept |
| AUSTRALIA Mount Isa | 32 | 19 |
| AUSTRALIA Tennant Creek | 34 | 16 |

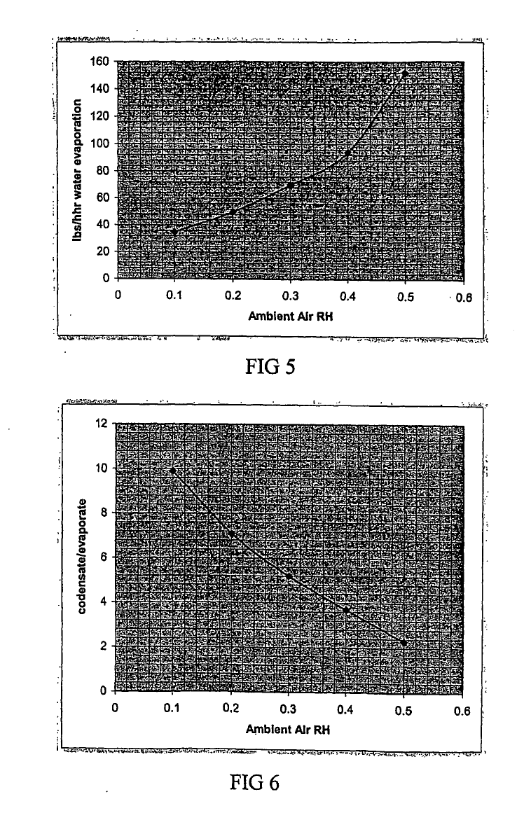

However, the embodiment utilizing ambient air for desiccant regeneration can also be utilized in more humid environmental conditions. FIG. 5 shows the the water loss per 1000 gallons/day (350 lbs/hr) in relation to ambient air relative humidity. Although more water is evaporated in regenerator 270 in a drier environment, the effect is linear. Accordingly, humid locations can utilized this ambient air desiccant drying technique, but not as effectively in comparison to a more arid region. FIG. 6 shows the effect of ambient air relative humidity on the amount of condensate production per desiccant water evaporation to the atmosphere. This ratio would be the energy reuse factor except that no steam was inputted to the tower system. The ratio gives a sense of the operational characteristic f factor where bigger is better.

In a humid environment, the ambient air desiccant regeneration embodiment can work by increasing the temperature of the air. For example, a solar collector can be used o heat water, which can be used to heat humid air to a higher temperature having lower relative humidity, e.g., about 20% relative humidity. Accordingly, air at about 80° F. (26.7° C.) and about 80% relative humidity in cities, such as Houston, New Orleans or Miami, could be heated to about 140° F. (60° C.) with about 20% relative humidity, using water at about 150° F. (65.6° C.). Even cooler but humid regions such as San Francisco, Calif. could use the desiccant ambient air regeneration by solar heating air to about 125° F. (51.7° C.) with about 135° F. (57.2° C.) hot water. These relatively low water temperatures could be achieved utilizing inexpensive single glazed flat plate solar collectors.

The desiccant can be a liquid solution of any known desiccant salt at a concentration of greater than about 40%, preferably greater than about 50%, and more preferably greater than about 60% by weight. Examples of useful desiccant salts include, but are not limited to, lithium bromide (10% maximum relative humidity producing), calcium chloride (30% maximum relative humidity producing), lithium chloride (20% maximum relative humidity producing), and mixtures thereof. The term “% maximum relative humidity producing,” as used herein, means the maximum dryness that a desiccant can provide to an air stream. For example, a 10% maximum relative humidity producing desiccant can dehydrate a saturated air stream at 87.8° C. containing about 1.7 moles of water vapor/mole of air to 0.067 moles of water vapor/mole of air at the same temperature. A solid desiccant can also be used to provide the desired dehydration. Nonlimiting examples of solid desiccants include solids of any of the above-described liquid desiccants, silica gel, and mixtures thereof. If a solid desiccant is used, however, a removable or moving bed configuration would be used to replace the spent solid desiccant.

The heat transfer wall (e.g., 110) can be made of any thermally conductive material or mixtures of these materials. Preferred are gas and liquid impermeable materials that are stable when placed in contact with the liquid mixture, e.g., will not be susceptible to corrosion, rust, pitting, or fouling. Examples of useful heat transfer wall materials include, but are not limited to, plastics, such as polyethylene, polypropylene, polyester, polycarbonate, polymers containing a combination of any of the monomers thereof, and mixtures thereof; metals, such as stainless steel (e.g., types 304, 316, and 347), brass, copper, platinum, silver, and alloys thereof; and composites, such as carbon fiber composites, fiber glass, and waxed paper.

Preferably, the heat transfer wall is wettable, which means that the liquid mixture feed flows in a thin liquid layer down the wall so that beading of the liquid mixture is not promoted. Thus, it is preferred to have a hydrophobic heat transfer wall for a hydrophobic liquid mixture, and a hydrophilic heat transfer wall for a hydrophilic liquid mixture. Nonlimiting examples of such heat transfer materials include water wettable plastic materials, such as Rexam M3D (commercially available from Rexam Graphics Company, located in South Hadley, Mass.); and durable plastics, such as the many Mylar films, which are commercially available from E.I. Dupont de Nemours Co. In an alternative embodiment, a thin layer of a wetting material can be placed upon any of the heat transfer materials described above. Nonlimiting examples of wetting materials include polyester gauze, cloth gauze, polypropylene cheesecloth, nylon cheesecloth, polypropylene/nylon cheesecloth, blends of these materials, and other fibrous materials. Many types of cheesecloths and gauzes are commercially available from ERC Wiping Products, Inc. located in Lynn, Mass. and from Carnegie Textiles located in Cincinnati, Ohio.

The remainder of the Dewvaporation apparatus, e.g., the outer walls 190 and 192, can be made of any gas and liquid impermeable material known in the art. Except for the preference for being water wettable, the materials recited above for use in the heat transfer wall can be used for the remainder of the Dewvaporation apparatus. If low strength materials, such as plastics are used, collapse of either or both chambers of the Dewvaporation apparatus can be a concern. Such a collapse can be prevented by employing any method known in the art, such as placing spacers or fins at various locations throughout the length of the chamber or filling the chamber with a filler. Preferably the filler is made of a high volume gas/air permeable material. A nonlimiting example of a useful gas/air permeable material is T-15 MR reticulated foam, commercially available from Crest Foam Industries located in Moonachie, N.J.

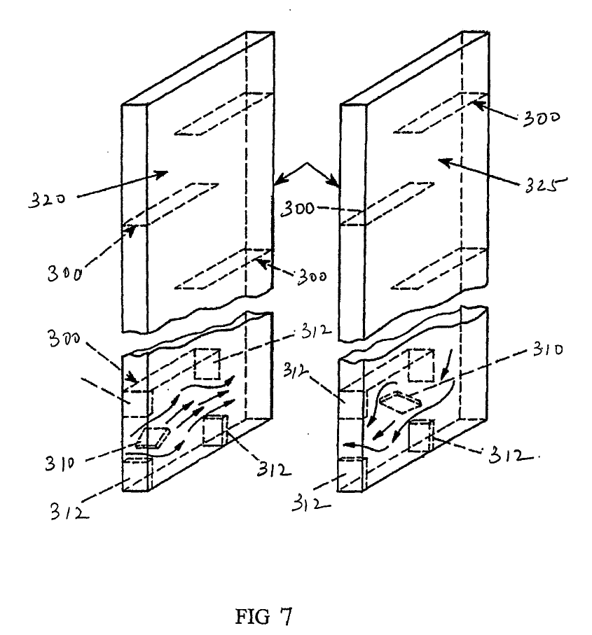

In another embodiment of the present invention, as illustrated by FIG. 7, the evaporation chamber portion and the dew-formation chamber portion of the Dewvaporation column can be configured to have a plurality of spacers 300, which are preferably placed at the same positions in both the chamber portions. These spacers can be positioned in any orientation (e.g., horizontal, vertical, and at any angle in between) and can be formed into any shape (e.g., straight or curved). When solids can be formed during the separation process, it is preferred to not have these spacers and/or the below described airflow guides, e.g., in the evaporation chamber portion where solids can form. Without wanting to be limited by any one theory, it is believed that the resulting “serpentine” air flow pattern provides better distribution of air flow for a given surface area of the heat transfer wall as a result of the decrease in channel width. Accordingly, the resulting channels and air flow rates can provide typical Reynolds Numbers of from about 100 to about 2500, preferably about 500 at the inlet of either portions of the Dewvaporation apparatus and from about 50 to about 200, preferably about 150 at the outlet of either portions of the Dewvaporation apparatus. The spacers can be made of any material that is stable when placed in contact with the liquid mixture or distillate, e.g., a material that is not susceptible to corrosion, rust, pitting, or fouling. Preferably, the spacers are made of water permeable materials so that the liquid can flow down the heat transfer wall and can be redistributed on the wall as it passes through the spacers. Nonlimiting examples of useful materials for spacers include plastic sponges, commercially available as A132C5G Ester urethane/charcoal color foam from Merryweather Foam Inc. located in Barberton, Ohio.

In this embodiment of FIG. 7, it is preferable to also include airflow guides 310 and 312 in the path of the carrier gas to better match the countercurrent airflow pattern on each side of the heat transfer wall. These airflow guides can be positioned in any orientation (e.g., horizontal, vertical, as depicted by guides 312, and at any angle in between) and can be formed into any shape (e.g., straight or curved) that would optimize the coincidence of the airflow in the dew-formation chamber and the evaporation chamber at any point in the apparatus. Vertically placed airflow guides 312 help to direct the carrier gas flow in the center of the passage. Airflow guides place in an angle 310 help to evenly distribute the gas within the passage. These airflow guides can be made of any stable material including the same materials used for the spacers described above. If the airflow guides are made of water impermeable material, however, it is preferred to attach the airflow guides to the outer wall of the apparatus and provide sufficient space between the airflow guide and the heat transfer wall to allow continuous flow of the liquid thereon.

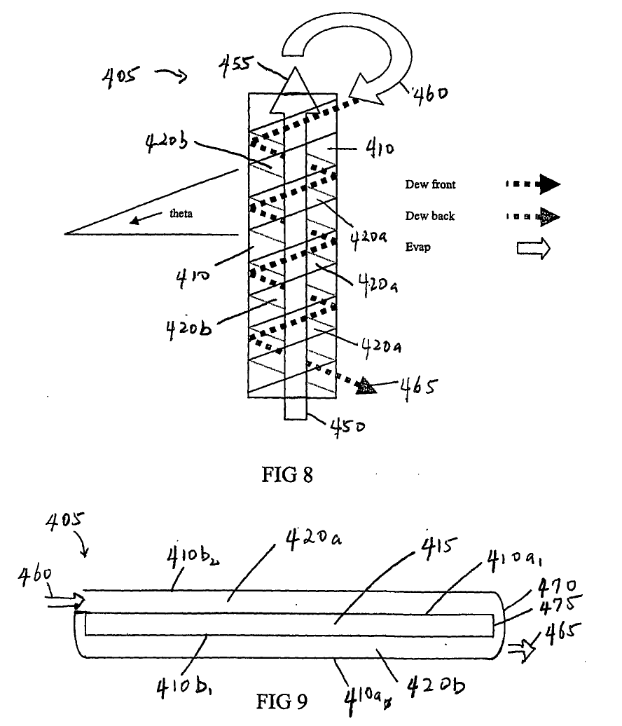

FIGS. 8 and 9 illustrate another embodiment of the present invention, wherein FIG. 8 provides a side, transparent view and FIG. 9 provides a top view. In this embodiment, column 405 includes a centrally located evaporation chamber 415, a helix-shaped dew-formation chamber 420a (front side) and 420b (back side) wrapped around the evaporation chamber, and a heat transfer walls 410a1 (front side) and 410b1 (back side) between the evaporation chamber and the dew-formation chamber. For simplicity, only one of the dew-formation chamber is illustrated. A second dew-formation chamber can be added in the same helix shape and positioned in the open areas to contact the heat transfer wall. Heat transfer walls 410a1 (front side) and 410b1 (back side) can be used to form the evaporation chamber. Carrier gas 450 enters the bottom of evaporation chamber 415, which is situated in the center as shown in FIG. 9, and becomes saturated carrier gas 455 at the top of the evaporation chamber. After processing, e.g., adding heat, the saturated carrier gas 460 enters dew-formation chamber 420, which is wrapped around evaporation chamber 415 in a helix-shape, as illustrated in FIGS. 8 and 9. The front side of dew-formation chamber 420a is illustrated in FIG. 8 with solid lines, and the saturated gas (“dew front”) in the front side is illustrated with dark dotted lines of the arrow. The back side of the dew-formation chamber 420b, which wraps around from the front side, is illustrated with dotted lines, and the saturated gas (“dew back”) in the back side is illustrated with gray dotted lines of the arrow. Due to the helix-shape, the dew-formation chamber 420 is angled at an angle theta in order to allow the condensed separable component formed in the dew-formation chamber to flow downward. The remaining carrier gas 465 and the distillate (not shown) exits at the bottom of dew-formation chamber 420.

The embodiment of FIGS. 8 and 9 can be easily construct from twin wall extrusion plastics, wherein the plastic is extruded to have a cross-section in the shape of a ladder. Useful twin wall extrusion plastics include twin-wall 4 mm polypropylene extruded sheets commercially available from Coroplast, Inc. located in Dallas, Tex. Looking at the ladder-like cross-sectional shape, one long leg can be used as one side of the heat transfer wall (e.g., 410a1) that forms one half of one evaporation chamber, and the other long leg can be used as the other side of the heat transfer wall (e.g., 310b2) that forms one half of an adjacent evaporation chamber. In this fashion, an array of alternating columns (i.e., an evaporation chamber with a dew-formation chamber wrapped around the evaporation chamber) can be formed. The spaces between the steps of the cross-section ladder, form the dew-formation chambers in the extruded sheet. The helix shape can be obtained by cutting the twin-wall extruded sheets at a desired angle, theta, to the dew-formation chambers formed by the steps of the cross-section ladder. The evaporation chamber is formed by securing two cut sheets with the flat sides (e.g., heat transfer walls 410a₁, and 410b₁, formed by extrusion of the long leg part of the cross-section ladder) facing each other. Accordingly, the flat sides of each piece on the outer sides of the dew-formation chambers will serve as heat transfer walls 410a₀ and 410b₂, which form half of the adjacent evaporation chambers. The open, angled ends of the dew-formation channels can be connected with tubed end pieces having outside wall 470 and inside wall 475 to connect a front side chamber 420a with a corresponding back side chamber 420b. The tubed end pieces can also be manufactured in an array by forming an end wall having openings or guiders to communicate the plurality of front side chambers with the plurality of back side chambers.

In another embodiment, the feed can be preheated by placing an additional fluid directing structure (e.g., a pipe), not shown, in evaporation chamber 415. Preferably, the size of the fluid directing structure is large enough to physically abut heat transfer walls 410a and 410b, thereby acting as a spacer for the heat transfer walls of the front side and the back side (e.g., 410a₁ and 410b₁).

1. A continuous contacting apparatus for separating a liquid component from a liquid mixture, the apparatus comprising:
a first chamber having first and second ends, an inlet and an outlet for a carrier gas, and an inlet and an outlet for a liquid mixture, wherein the inlet for the liquid mixture is located between the first and second ends, the outlet for the liquid mixture and the inlet for the carrier gas are located at the second end of the first chamber, and the outlet for the carrier gas is located at the first end;
a second chamber having first and second ends, an inlet and an outlet for a carrier gas, and an inlet and outlet for the separable liquid component, wherein the inlet for the carrier gas and the inlet for the liquid component are located at the first end of the second chamber, and the outlet for the carrier gas and the outlet for the separable liquid component is located at the second end of the second chamber; and
a common heat transfer wall capable of providing thermal communication between the first chamber and the second chamber.

2. The apparatus of claim 1, wherein the inlet for the liquid mixture is located about the middle of first and second ends of the first chamber; wherein the inlet for the carrier gas and the inlet for the liquid component at the first end of the second chamber is a single common inlet; and wherein one outlet located at the second end of the second chamber is used as the outlet for the carrier gas and the outlet for the separable liquid component.

3. The apparatus of claim 1 further comprising,
a first heat exchanger having a cooling chamber with an inlet and an outlet in thermal communication with a heating chamber with an inlet and an outlet, wherein the 30 inlet of the cooling chamber is connected to the outlet for the carrier gas of the first chamber and the outlet of the cooling chamber is connected to the inlet for the carrier gas of the second chamber; and
a second heat exchanger having a cooling chamber with an inlet and an outlet in thermal communication with a heating chamber with an inlet and an outlet, wherein the inlet of the cooling chamber is connected to the outlet for the carrier gas of the second chamber and the outlet of the cooling chamber is connected to the inlet for the carrier gas 5 of the first chamber.

4. The apparatus of claim 3 further comprising,
a feeding device for providing the liquid mixture onto the first chamber side of the heat transfer wall; and
a mover for providing a flow of a carrier gas through the chambers, wherein the gas flow in the first chamber is countercurrent to the gas flow in the second chamber.

5. The apparatus of claim 4 further comprising,
a heating apparatus for heating at least a portion of the carrier gas from the second chamber, wherein the carrier gas is removed from the second chamber at about the corresponding location from the inlet for the liquid mixture in the first chamber and returned to the second chamber at a location between the location of removal and the second end of the second chamber.

6. The apparatus of claim 1, further comprising a plurality of spacers placed in at least one chamber.

7. The apparatus of claim 6, wherein the plurality of spacers are positioned to provide a serpentine-shaped channel for the carrier gas.

8. The apparatus of claim 7 further comprising airflow guides.

9. The apparatus of claim 8, wherein only the second chamber has the plurality of spacers and airflow guides.

10. The apparatus of claim 1, wherein the first chamber is centrally located and the second chamber wraps around the first chamber in a helix shape.

11. The apparatus of claim 10 wherein the inlet for the liquid mixture is located at the first end of the first chamber.

12. A continuous contacting apparatus for exchanging heat released by a desiccant, the apparatus comprising
a heat-releasing chamber having an inlet and an outlet for a gas at least partially saturated with a component absorbable by a desiccant, and an inlet and an outlet for a desiccant;
a heat-absorbing chamber having an inlet and an outlet for a gas to be heated;
a common heat transfer wall capable of providing thermal communication between the heat-releasing chamber and the heat producing chamber; and
a desiccant regenerator having an inlet and an outlet, wherein the outlet provides a regenerated desiccant stream to the desiccant inlet of the heat-releasing chamber, and wherein the inlet receives spent desiccant stream from the desiccant outlet of the heat-releasing chamber.

13. The apparatus of claim 12, wherein the desiccant inlet of the heat-releasing chamber is situated to place the desiccant onto the heat-releasing side of the heat transfer wall.

14. The apparatus of claim 12 further comprising an inlet and an outlet in the heat-absorbing chamber for a liquid having a component evaporable into the gas.

15. The apparatus of claim 14, wherein the inlet for the liquid having the evaporable component is situated to place the liquid onto the heat-absorbing side of the heat transfer wall.

16. The apparatus of claim 12, wherein the desiccant regenerator applies heat to the spent desiccant for regeneration.

17. The apparatus of claim 12, wherein the desiccant regenerator contacts the spent desiccant with heated air for regeneration.

18. The apparatus of claim 12, wherein the desiccant regenerator contacts the spent desiccant with ambient air for regeneration.

19. The apparatus of claim 18 further comprising a heat exchanger situated between the heat releasing chamber and the desiccant regenerated, the heat exchanger transferring heat from the spent desiccant stream to the regenerated desiccant stream.

20. The apparatus of claim 12, wherein the desiccant is selected from the group consisting of lithium bromide, calcium chloride, lithium chloride, and mixtures thereof.
